(19) United States
(12) Patent Application Publication
(10) Pub. No.: US 2026/0110159 A1
(43) Pub. Date: Apr. 23, 2026

(54) Water Outlet Device and Aerator Thereof

(71) Applicant: FUJIAN DOMOO SANITARY WARE TECHNOLOGY CO., LTD, Fujian (CN)

(72) Inventors: Xiaofa Lin, Fujian (CN); Xiaoshan Lin, Fujian (CN); Zhiwei Chen, Fujian (CN); Pansheng Liang, Fujian (CN); Xiaoqing Deng, Fujian (CN); Qiqiao Liu, Fujian (CN)

(21) Appl. No.: 19/020,091

(22) Filed: Jan. 14, 2025

(30) Foreign Application Priority Data
Oct. 18, 2024 (CN) 202411459485.0

(51) Int. Cl. E03C 1/084

(52) U.S. Cl. CPC E03C 1/084; E03C 2201/40

(57) ABSTRACT

A water outlet device and an aerator thereof are provided. The aerator includes: a housing provided with a mounting cavity, and a water inlet, a water outlet and an air inlet all communicated with the mounting cavity; an aerator mesh, an edge of the aerator mesh being connected to the housing, the aerator mesh being capable of covering the water outlet and provided with multiple first mesh holes and a dirt outlet having a cross-sectional area larger than that of a first mesh hole; an acceleration member provided in the mounting cavity and slidable in a direction toward the aerator mesh and in a direction away from the aerator mesh, abutting against an area of the aerator mesh close to the dirt outlet; and an elastic member for applying an elastic force toward the acceleration member to the area of the aerator mesh close to the dirt outlet.

### CROSS-REFERENCE TO RELATED APPLICATION

The present application claims priority to Chinese Patent Application No. 202411459485.0 filed to the CNIPA on Oct. 18, 2024. Contents of the above-identified application are incorporated into the present application by reference.

### TECHNICAL FIELD

The present application relates to the field of kitchen and bathroom technologies, and particularly relates to a water outlet device and an aerator of the water outlet device.

### BACKGROUND

The principle of an existing microbubble-forming aerator is to form negative pressure by high-speed water flow to suck air so as to form a water-gas mixed fluid, and then impinge a high-speed water-gas mixed fluid on an aerator filter mesh, which cuts bubbles in the water-gas mixed fluid, thereby forming micro-bubbles in the water-gas mixed fluid.

During the long-term use of the existing microbubble-forming aerator, dirt in the water will block a mesh hole of the aerator filter mesh, causing the aerator filter mesh to be dirty and blocked, and affecting the water outflow of the microbubble-forming aerator.

### SUMMARY

The technical problem to be solved by the present application is how to avoid dirty and blockage of the aerator filter mesh.

In order to solve the above technical problems, the present application proposes an aerator. The aerator includes: a housing, provided with a mounting cavity, and a water inlet, a water outlet and an air inlet all communicated with the mounting cavity; an aerator mesh having flexibility or elasticity, an edge of the aerator mesh being connected to the housing, and the aerator mesh being capable of covering the water outlet, and provided with multiple first mesh holes and a dirt outlet having a cross-sectional area larger than that of a first mesh hole; an acceleration member, provided in the mounting cavity and slidable in a direction toward the aerator mesh and in a direction away from the aerator mesh, the acceleration member abutting against an area of the aerator mesh close to the dirt outlet; and an elastic member, for applying an elastic force toward the acceleration member to the area of the aerator mesh close to the dirt outlet. The acceleration member is configured to slide in the direction toward the aerator mesh under an action of a water flow to prop the aerator mesh to arch in a direction away from the acceleration member.

When water is injected into the water inlet of the housing, the water flow pushes the acceleration member to slide in the direction toward the aerator mesh and prop the aerator mesh to arch in the direction away from the acceleration member, and when stopping injection of water into the water inlet of the housing, the elastic member pushes the aerator mesh and the acceleration member to move in opposite directions. In this way, the acceleration member can slide back and forth and drive the aerator mesh to move back and forth in the process of switching back and forth between allowing water to inflow and stopping the inflow of water from the water inlet, so that the scale and impurities on the aerator mesh are loosened and peeled off. At the same time, the aerator mesh arches in the direction away from the acceleration member 4 when water enters the water inlet, so that the scale and impurities separated from the aerator mesh can move along an inclined surface of the aerator mesh to the dirt outlet at the top most of the aerator mesh under the drive of the water flow, and finally is discharged from the dirt outlet, thereby achieving a function of descaling and impurities removal, which may prevent the aerator mesh from being dirty and blocked.

Other features and advantages of the present application will be set forth in the description which follows, and in part will become apparent from the description, or may be learned by practice of the present application. Other advantages of the present application can be realized and obtained by embodiments described in the description and the drawings.

### BRIEF DESCRIPTION OF THE DRAWINGS

The drawings are used to provide an understanding of technical solutions of the present application, and constitute a part of the specification. They are used to explain the technical solutions of the present application together with the embodiments of the present application, but do not constitute a limitation on the technical solutions of the present application.

FIG. 1 is a perspective schematic view of an aerator according to an embodiment of the present application.

FIG. 2 is a perspective schematic view of an aerator according to an embodiment of the present application from another perspective.

FIG. 3 is a schematic exploded view of an aerator according to an embodiment of the present application.

FIG. 4 is a schematic exploded view of an aerator according to an embodiment of the present application from another perspective.

FIG. 5 is a schematic front view of an aerator according to an embodiment of the present application.

FIG. 6 is a schematic sectional view taken along an A-A plane in FIG. 5.

FIG. 7 is a schematic sectional view of an aerator when water is supplied to a water inlet according to an embodiment of the present application.

FIG. 8 is a perspective schematic view of an acceleration member and an air intake frame according to an embodiment of the present application.

FIG. 9 is a perspective schematic view of an acceleration member and an air intake frame according to an embodiment of the present application from another perspective.

FIG. 10 is a schematic full sectional view of an aerator according to an embodiment of the present application.

FIG. 11 is a perspective schematic view of another acceleration member and an air intake frame according to an embodiment of the present application.

FIG. 12 is a perspective schematic view of another acceleration member and an air intake frame in an embodiment of the present application from another perspective.

FIG. 13 is a schematic full sectional view of an aerator according to an embodiment of the present application.

### DETAILED DESCRIPTION

The present application describes multiple embodiments, but the description is exemplary and not limiting, and it will be apparent to those of ordinary skills in the art that more embodiments and implementations may be included within the scope of the embodiments described by the present application. Although many possible combinations of features are shown in the drawings and discussed in the detailed description, many other combinations of the disclosed features are also possible. Unless specifically limited, any feature or element of any embodiment may be used in combination with, or may substitute for, any other feature or element of any other embodiment.

The present application includes and contemplates combinations with features and elements known to those of ordinary skills in the art. The disclosed embodiments, features, and elements of the present application may also be combined with any conventional features or elements to form a unique inventive solution. Any feature or element of any embodiment may also be combined with feature(s) or element(s) from other inventive solution to form another unique inventive solution. Accordingly, it should be understood that any of the features shown and/or discussed in the present application may be implemented alone or in any suitable combination. Thus, the embodiments are not subjected to limitations other than those made in accordance with the appended claims and their equivalent substitutions. In addition, various modifications and changes may be made within the protection scope of the appended claims.

Furthermore, when describing representative embodiments, the specification may have presented a method and/or process as a particular sequence of steps. However, to the extent that the method or process does not depend on the specific order of steps described herein, the method or process should not be limited to the specific order of steps described. As will be understood by those of ordinary skills in the art, other order of steps is also possible. Accordingly, a specific order of steps set forth in the specification should not be construed as limitations on the claims. Furthermore, the claims for the method and/or process should not be limited to the steps which are performed in the written order. Those skilled in the art can readily understand that these orders can be changed and the changed orders still remain within the spirit and scope of the embodiments of the present application.

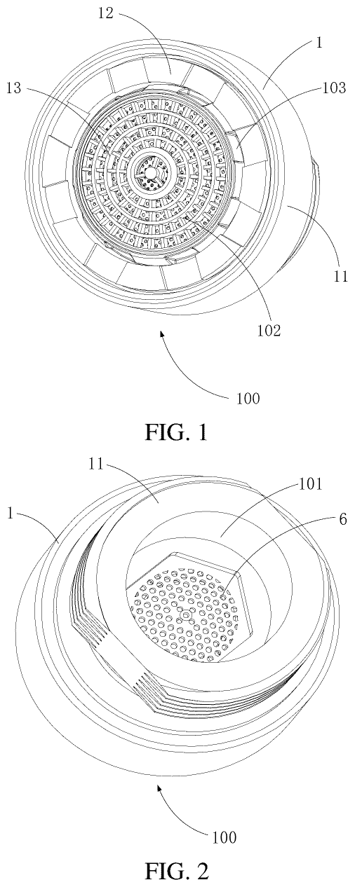

As shown in FIGS. 1 to 4, FIGS. 1 to 4 show an aerator 100 according to an embodiment of the present application. The aerator 100 includes a housing 1, an aerator mesh 2, an air intake frame 5, an elastic member 3, and an acceleration member 4.

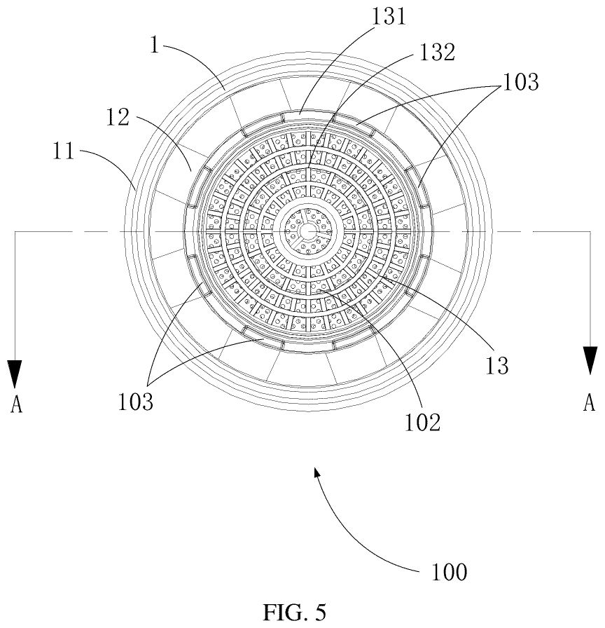

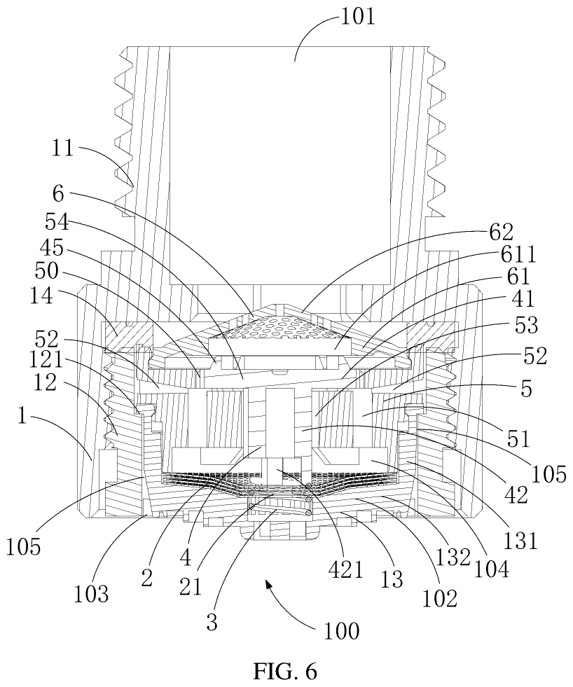

As shown in FIGS. 5 and 6, a mounting cavity 104 is provided in the housing 1, and a water inlet 101, a water outlet 102, and an air inlet 103 are further provided on the housing 1. The water inlet 101, the water outlet 102, and the air inlet 103 all communicate with the mounting cavity 104. In this embodiment, the housing 1 includes an outer cylinder 11, an inner cylinder 12, and a face cover 13. The outer cylinder 11 is configured in a substantially circular tubular shape. The water inlet 101 is provided at one end of the outer cylinder 11, and an end of the outer cylinder 11 facing away from the water inlet 101 is provided with an internal thread. The inner cylinder 12 is provided in a cylindrical shape. The inner cylinder 12 is provided with an external thread, the inner cylinder 12 is provided in the end of the outer cylinder 11 provided with the internal thread, and the external thread of the inner cylinder 12 is screwed into the internal thread of the outer cylinder 11, thus forming a threaded connection between the inner cylinder 12 and the outer cylinder 11. The face cover 13 is located at one end of the inner cylinder 12 facing away from the water inlet 101, and the face cover 13 is fixed relative to the inner cylinder 12. The water outlet 102 is provided on the face cover 13. The face cover 13 and the inner cylinder 12 enclose the mounting cavity 104. The air inlet 103 is located between one end of the face cover 13 facing away from the water inlet 101 and one end of the inner cylinder 12 facing away from the water inlet 101. The face cover 13 includes a connection cylinder 131 and a support frame 132. The connection cylinder 131 is configured as a cylindrical structure. The connection cylinder 131 is provided in the inner cylinder 12 and coaxially with the inner cylinder 12. An outer peripheral wall of the connection cylinder 131 is recessed inward to form an air intake groove 1311. The air intake groove 1311 extends from one end of the connection cylinder 131 to the other end of the connection cylinder 131. An inner wall of the air intake groove 1311 and an inner wall of the inner cylinder 12 enclose an air intake passage 105. The air intake passage 105 extends from the air inlet 103 to the mounting cavity 104. The air inlet 103 communicates with the mounting cavity 104 through the air intake passage 105. The water inlet 101 is used for externally connecting a water supply pipeline. The support frame 132 covers one end of the connection cylinder 131 facing away from the water inlet 101. The water outlet 102 is provided on the support frame 132. Multiple water outlets 102 may be provided on the support frame 132, and the support frame 132 is preferably provided as a mesh structure.

The aerator mesh 2 is flexible or elastic. The aerator mesh 2 may be made of a flexible material or an elastic material. The aerator mesh 2 may be a mesh structure woven with a fabric. The aerator mesh 2 may be a nylon mesh. The aerator mesh 2 is provided in the mounting cavity 104, and an edge of the aerator mesh 2 is fixed to the housing 1. The aerator mesh 2 may be sandwiched between the support frame 132 and the air intake frame 5. The aerator mesh 2 may be provided within the face cover 13 and the edge of the aerator mesh 2 is fixed on the face cover 13. The aerator mesh 2 can cover the water outlet 102. The aerator mesh 2 is provided with multiple first mesh holes 22 and a dirt outlet 21. Both the first mesh holes 22 and the dirt outlet 21 penetrate the aerator mesh 2. The multiple first mesh holes 22 are densely distributed on the aerator mesh 2. A cross-sectional area of the dirt outlet 21 is larger than a cross-sectional area of a first mesh hole 22. The dirt outlet 21 may be provided in a central area of the aerator mesh 2.

The air intake frame 5 is provided in the mounting cavity 104 of the housing 1, and the air intake frame 5 is fixed to the housing 1. The air intake frame 5 is located on a side of the aerator mesh 2 close to the water inlet 101 of the housing 1, and the air intake frame 5 is interposed between the aerator mesh 2 and the water inlet 101. The air intake frame 5 is provided with a mixing flow passage 51 and an air suction hole 52. The mixing flow passage 51 extends from one end of the air intake frame 5 facing the water inlet 101 of the housing 1 to one end of the air intake frame 5 facing the water outlet 102 of the housing 1. An end of the mixing flow passage 51 facing the water inlet 101 is provided with an inlet port and the inlet port is communicated with the water inlet 101 of the housing 1. An end of the mixing flow passage 51 facing the water outlet 102 is provided with an outlet port and the outlet port faces the aerator mesh 2. The mixing flow passage 51 is communicated with the water outlet 102 through the first mesh hole 22 and the dirt outlet 21 on the aerator mesh 2. An extension direction of the air suction hole 52 and an extension direction of the mixing flow passage 51 may be perpendicular to each other or may be inclined to each other. One end of the air suction hole 52 communicates with the inlet port of the mixing flow passage 51, the other end of the air suction hole 52 communicates with an end of the air intake passage 105 extending to the mounting cavity 104, and the air suction hole 52 communicates with the air inlet 103 of the housing 1 through the air intake passage 105.

The acceleration member 4 is disposed within the mounting cavity 104. The acceleration member 4 is slidably connected to the air intake frame 5. The acceleration member 4 can slide either in a direction toward the aerator mesh 2 or in a direction away from the aerator mesh 2. The acceleration member 4 abuts against an area of the aerator mesh 2 close to the dirt outlet 21, and the acceleration member 4 may abut against a periphery of the dirt outlet 21. The acceleration member 4 can accelerate the water flow input into the mounting cavity 104 of the housing 1 from the water inlet 101, and to introduce the accelerated water flow into the inlet port of the mixing flow passage 51 of the air intake frame 5. The acceleration member 4 can further slide in the direction toward the aerator mesh 2 under an action of the water flow, so as to prop the aerator mesh 2 to arch in a direction away from the acceleration member 4.

The elastic member 3 has elasticity. The elastic member 3 may be a spring. The elastic member 3 is connected to the housing 1. The elastic member 3 may be provided on a side of the aerator mesh 2 facing away from the acceleration member 4. The elastic member 3 is sandwiched between the support frame 132 of the face cover 13 and the aerator mesh 2. The elastic member 3 abuts against an area of the aerator mesh 2 close to the dirt outlet 21. The elastic member 3 is in an elastically compressed state to apply an elastic force to the area of the aerator mesh 2 close to the dirt outlet 21, and a direction of the elastic force is a direction towards the acceleration member 4.

When the aerator 100 is used, water is injected into the water inlet 101 of the housing 1, and the acceleration member 4 can accelerate the water flow input from the water inlet 101 and feed the accelerated water flow into the inlet port of the mixing flow passage 51 of the air intake frame 5. Since the water flow velocity at the inlet port of the mixing flow passage 51 is relatively high, pressure at the inlet port of the mixing flow passage 51 is negative pressure, that is, the pressure at the inlet port is lower than the atmospheric pressure. Under an action of atmospheric pressure, external air enters the air suction hole 52 from the air inlet 103 of the housing 1, and then enters the inlet port of the mixing flow passage 51 from the air suction hole 52. The air mixes with the high-speed water flow at the inlet port of the mixing flow passage 51 to form a water-gas mixed fluid, which enters the mixing flow passage 51, and then is sprayed toward the aerator mesh 2 through the outlet port of the mixing flow passage 51. In this way, the air intake frame 5 can suck the external air from the air inlet 103 by using the negative pressure generated by the accelerated water flow, so that the water flow and the air are mixed into a water-gas mixed fluid, and the water-gas mixed fluid is sprayed toward the aerator mesh 2. The aerator mesh 2 cuts bubbles in the water-gas mixed fluid passing through the first mesh holes 22, thereby forming micro-bubbles in the water-gas mixed fluid, and the fluid having the micro-bubbles is finally output from the housing 1 through the water outlet 102.

When water is injected into the water inlet 101 of the housing 1, the water flow pushes the acceleration member 4 to slide in the direction toward the aerator mesh 2 and prop the aerator mesh 2 to arch in the direction away from the acceleration member 4, and when stopping injection of water into the water inlet 101 of the housing 1, the elastic member 3 pushes the aerator mesh 2 and the acceleration member 4 to move in an opposite direction. In this way, the acceleration member 4 can slide back and forth and drive the aerator mesh 2 to move back and forth in the process of switching back and forth between allowing water to inflow and stopping the inflow of water from the water inlet 101, so that the scale and impurities on the aerator mesh 2 are loosened and peeled off. At the same time, the aerator mesh 2 arches in a direction away from the acceleration member 4 when water enters the water inlet 101, so that the scale and impurities separated from the aerator mesh 2 can move along an inclined surface of the aerator mesh 2 to the dirt outlet 21 at the topmost end of the aerator mesh 2 under a drive of water flow, and finally is discharged from the dirt outlet 21, thereby achieving a function of descaling and impurities removal.

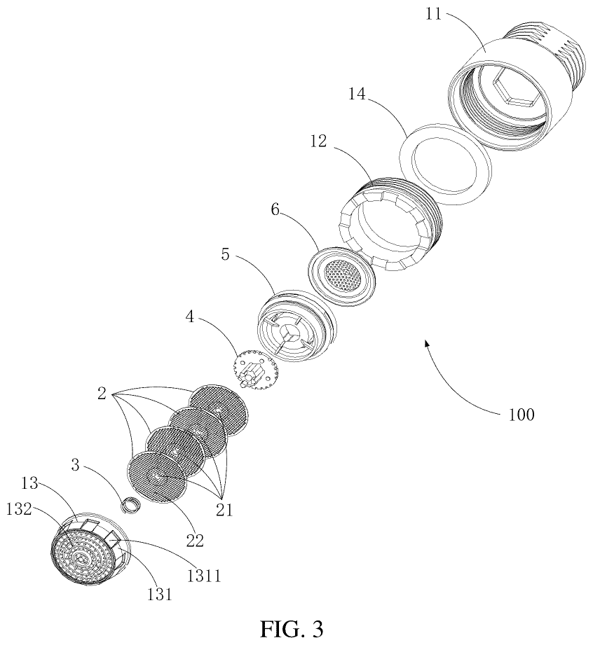

In an illustrative embodiment, as shown in FIG. 3, the dirt outlet 21 is provided in the central portion of the aerator mesh 2.

The dirt outlet 21 is provided in the central portion of the aerator mesh 2, and both the acceleration member 4 and the elastic member 3 abut against a central area of the aerator mesh 2, which is beneficial for uniform deformation throughout the aerator mesh 2, and it is not easy to have a blind spot in descaling and the aerator mesh 2 is also uniformly stressed throughout, so as to prolong a service life of the aerator mesh 2. At the same time, the aerator mesh 2 can prop into a substantially tapered surface shape by the acceleration member 4, and dirt peeled off from the aerator mesh 2 can be smoothly discharged.

In an illustrative embodiment, as shown in FIG. 3, multiple aerator meshes 2 are provided, for example, four aerator meshes 2 are provided. The multiple aerator meshes 2 are sequentially stacked and arranged between the acceleration member 4 and the elastic member 3. Each aerator mesh 2 is provided with a dirt outlet 21. The dirt outlets 21 on the multiple aerator meshes 2 are aligned in a stacking direction of the multiple aerator meshes 2.

The multiple aerator meshes 2 are sandwiched between the acceleration member 4 and the elastic member 3, and the acceleration member 4 and the elastic member 3 each abut against the closest aerator mesh 2, respectively. The layers of the multiple aerator meshes 2 cut the bubbles in the water-gas mixed fluid, which can cut the bubbles in the water-gas mixed fluid into denser micro-bubbles and increase an amount of bubbles. At the same time, the dirt outlets 21 on the multiple aerator meshes 2 are aligned with each other, and dirt may be discharged outwardly through the dirt outlets 21 on the multiple aerator meshes 2 in sequence.

Existing micro-bubble technologies all use particularly small acceleration holes to accelerate water flow. The smaller acceleration holes have high processing cost, and are easy to be blocked and accumulate scale. After the acceleration holes are dirty and blocked, the flow rate of water flow will be reduced, affecting the air suction effect and the effect of impinging the filter screen to cut micro-bubbles. To solve this problem, the present application has also made the following improvements.

As shown in FIGS. 6, 8, 9, and 10, a mounting groove 54 is provided at one end of the air intake frame 5 facing the water inlet 101 of the housing 1. The mounting groove 54 is provided in the central portion of the end of the air intake frame 5 facing the water inlet 101 of the housing 1. The mounting groove 54 may be a shallow groove. A groove bottom of the mounting groove 54 may be planar. The groove bottom of the mounting groove 54 may be perpendicular to the water inlet direction of the water inlet 101 of the housing 1. An opening of the mounting groove 54 faces the water inlet 101 of the housing 1.

The mixing flow passage 51 of the air intake frame 5 extends from an edge of the groove bottom of the mounting groove 54 to one end of the air intake frame 5 facing the water outlet 102. The mixing flow passage 51 may be a straight passage perpendicular to the groove bottom of the mounting groove 54, and parallel to the water inlet direction of the water inlet 101.

The air intake frame 5 is further provided with a slideway 53. The slideway 53 is a straight through hole, and the slideway 53 extends from a central portion of the groove bottom of the mounting groove 54 to a central portion of one end of the air intake frame 5 facing the water outlet 102. An extension direction of the slideway 53 is parallel to an extension direction of the mixing flow passage 51.

The acceleration member 4 includes a pressure bearing plate 41 and a support column 42. The pressure bearing plate 41 may be configured in a flat plate shape. A plate surface of the pressure bearing plate 41 is parallel to the groove bottom of the mounting groove 54 of the air intake frame 5, and perpendicular to the water inlet direction of the water inlet 101 of the mounting groove 54. The pressure bearing plate 41 is at least partially accommodated in the mounting groove 54. There is a gap between the pressure bearing plate 41 and the mounting groove 54. A thickness of the pressure bearing plate 41 may be smaller than a depth of the mounting groove 54. The support column 42 is configured as a straight bar. The support column 42 is perpendicular to the pressure bearing plate 41. One end of the support column 42 is connected to a central portion of the pressure bearing plate 41. The support column 42 may be a hollow tubular structure. The support column 42 penetrates the slideway 53 of the air intake frame 5, and the support column 42 can slide along an extension direction of the slideway 53 to realize a sliding connection between the acceleration member 4 and the air intake frame 5. An end of the support column 42 facing away from the pressure bearing plate 41 abuts against an area of the aerator mesh 2 close to the dirt outlet 21.

A side surface of the pressure bearing plate 41 and a side surface of the mounting groove 54 enclose an acceleration passage 50. One end of the acceleration passage 50 communicates with the water inlet 101 of the housing 1. The other end of the acceleration passage 50 faces an inlet port of the mixing flow passage 51. A cross-sectional area of the acceleration passage 50 is smaller than a cross-sectional area of the mixing flow passage 51, and the cross-sectional area of the acceleration passage 50 is also smaller than an area of the water inlet 101 of the housing 1.

In this way, after the water flow is input from the water inlet 101 of the housing 1 into the mounting cavity 104, pressure is applied to the pressure bearing plate 41 to push the acceleration member 4 so that the acceleration member 4 can slide toward the aerator mesh 2 in an extension direction of the slideway 53, the support column 42 props the aerator mesh 2 to arch in a direction away from the acceleration member 4, and the elastic member 3 is further compressed. Since the cross-sectional area at the acceleration passage 50 is relatively small, a constriction is formed at the acceleration passage 50, the water flow may be accelerated when flowing through the acceleration passage 50, and the accelerated water flow is sprayed to an inlet port of the mixing flow passage 51, whereby a negative pressure may be formed at the inlet port, and air may be sucked from the air inlet 103 by using the negative pressure. In particular, under an action of the water pressure and the elastic member 3, the acceleration member 4 can reciprocally slide relative to the air intake frame 5, and there is a relative motion between the side surface of the pressure bearing plate 41 and the side surface of the mounting groove 54. In this way, the scale and impurities in the acceleration passage 50 may be removed, and the scale and impurities may be discharged from the dirt outlet 21 and the water outlet 102 to the external of the housing 1 along with the water flow, so as to avoid the dirt and blockage in the acceleration passage 50.

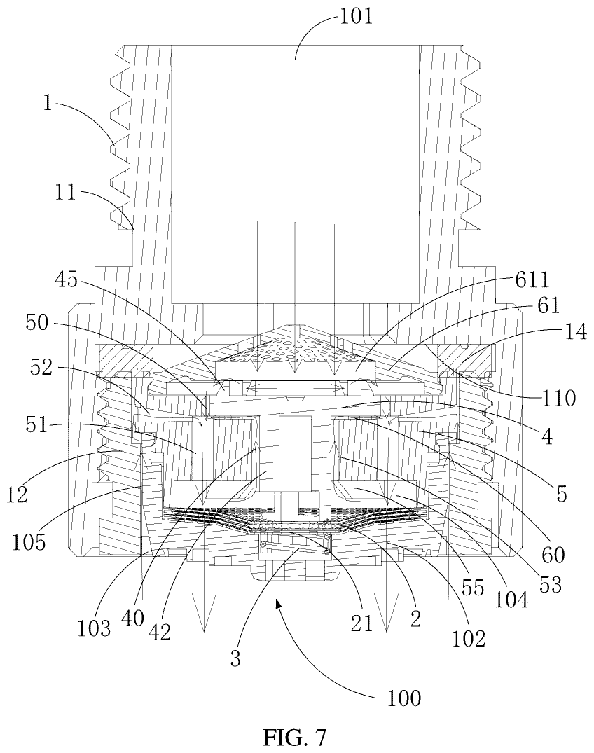

In an illustrative embodiment, as shown in FIG. 7, a mixing flow cavity 104 is enclosed between the aerator mesh 2 and the air intake frame 5. One end of the air intake frame 5 facing the aerator mesh 2 is provided with a second groove 55, the aerator mesh 2 covers an opening of the second groove 55, and an inner wall of the second groove 55 and a surface of the aerator mesh 2 facing the second groove 55 enclose the mixing flow cavity 104. A gap between the slideway 53 and the support column 42 forms a first return passage 40. One end of the first return passage 40 communicates with the mixing flow cavity 104. A gap between the groove bottom of the mounting groove 54 and the pressure bearing plate 41 forms a second return passage 60. One end of the first return passage 40 facing away from the mixing flow cavity 104 communicates with one end of the second return passage 60. One end of the second return passage 60 facing away from the first return passage 40 communicates with the inlet port of the mixing flow passage 51.

In this way, when the water flow is injected into the water inlet 101, the accelerated water flow is sprayed from the acceleration passage 50 to the inlet port of the mixing flow passage 51 to form a negative pressure at the inlet port, and the water-gas mixed fluid flows through the mixing flow passage 51 and then enters the mixing flow cavity 104. A part of the water-gas mixed fluid in the mixing flow cavity 104 flows back to the inlet port of the mixing flow passage 51 along the first return passage 40 and the second return passage 60 under a drive of the water pressure, and is cut by the high-speed water flow sprayed from the acceleration passage 50 to produce more micro-bubbles. Thus, the water-gas mixed fluid circulates in the mixing flow passage 51, the mixing flow cavity 104, the first return passage 40, and the second return passage 60, which may further increase the amount of micro-bubbles. At the same time, when a part of the water-gas mixed fluid is circulated, it may also carry the dirt fallen off the aerator mesh 2 in the mixing flow cavity 104 to the dirt outlet 21, so that the dirt may be quickly discharged.

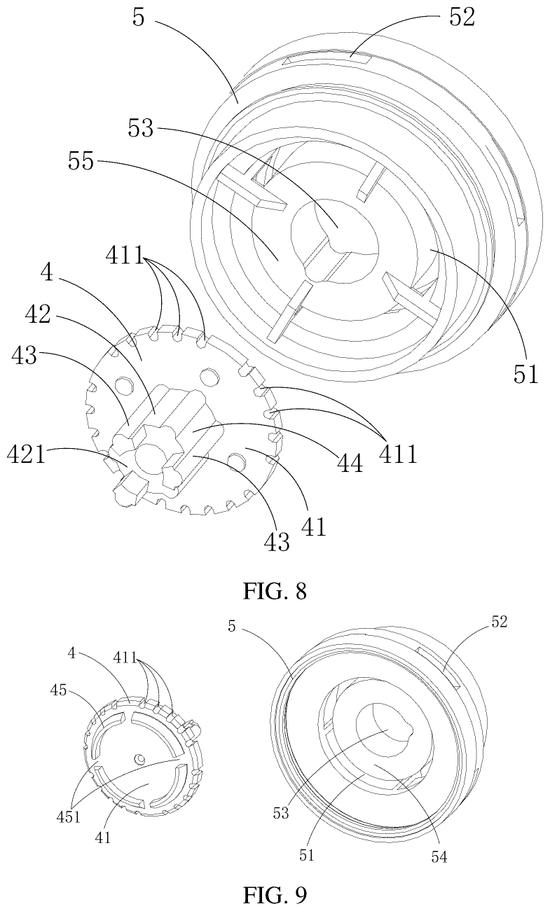

In an illustrative embodiment, as shown in FIGS. 8-10, the side surface of the pressure bearing plate 41 is recessed inward to form a first groove 411. A shape of a cross section of the first groove 411 is not limited. The first groove 411 extends from one plate surface of the pressure bearing plate 41 to the other plate surface of the pressure bearing plate 41, and the first groove 411 perpendicularly penetrates the pressure bearing plate 41. The side surface of the mounting groove 54 covers an opening of the first groove 411, and an inner wall of the first groove 411 and the side surface of the mounting groove 54 enclose the acceleration passage 50. Multiple first grooves 411 are provided on the pressure bearing plate 41, and the multiple first grooves 411 are uniformly distributed around a circumferential direction of the pressure bearing plate 41. The mixing flow passage 51 is configured as an annular passage, a cross section of the mixing flow passage 51 may be in a shape of circular annulus, and the mixing flow passage 51 surrounds the slideway 53 and surrounds the first return passage 40. The multiple first grooves 411 on the pressure bearing plate 41 are all aligned with the inlet port of the mixing flow passage 51.

In this way, the multiple acceleration passages 50 surrounding the pressure bearing plate 41 may uniformly spray high-speed water flow into the inlet port of the annular mixing flow passage 51 in a circumferential direction of the mixing flow passage 51, and further, the outlet port of the annular mixing flow passage 51 may uniformly output the water-gas mixed fluid. When a part of the water-gas mixed fluid flows back to the first return passage 40, dirt is driven from an edge of the aerator mesh 2 to the dirt outlet 21, so that dirt fallen off throughout the aerator mesh 2 may be driven to the dirt outlet 21, which may remove the dirt completely. At the same time, the cross-sectional area of the acceleration passage 50 of such structure may be set to be larger, so that the acceleration passage 50 is less likely to be dirty and blocked. The cross-sectional area of the acceleration passage 50 of such structure may be set to be smaller, for example, a width and a depth of the first groove 411 are set to be 0.3 mm or less. Even if the cross-sectional area of the acceleration passage 50 is set to be very small, since the acceleration member 4 may slide reciprocally with respect to the air intake frame 5 to remove scale and impurities in the acceleration passage 50, the acceleration passage 50 with a smaller cross-sectional area will not be dirty and blocked.

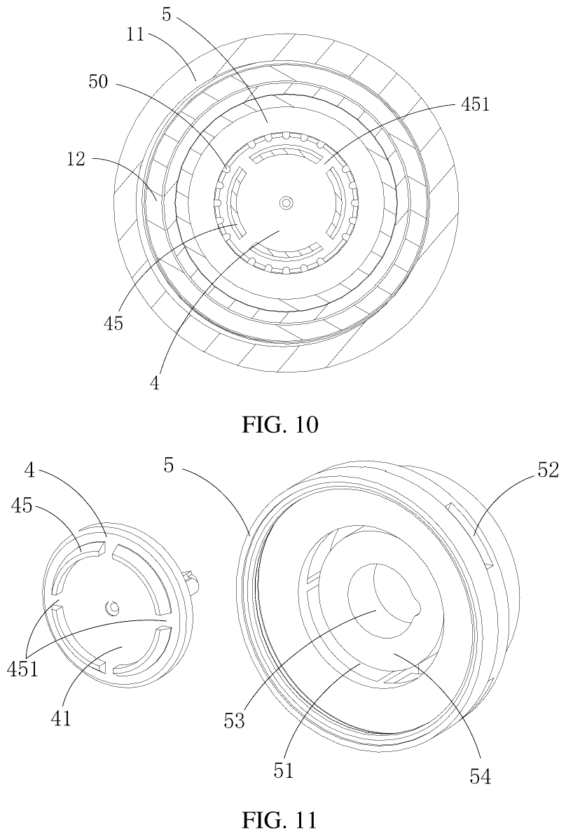

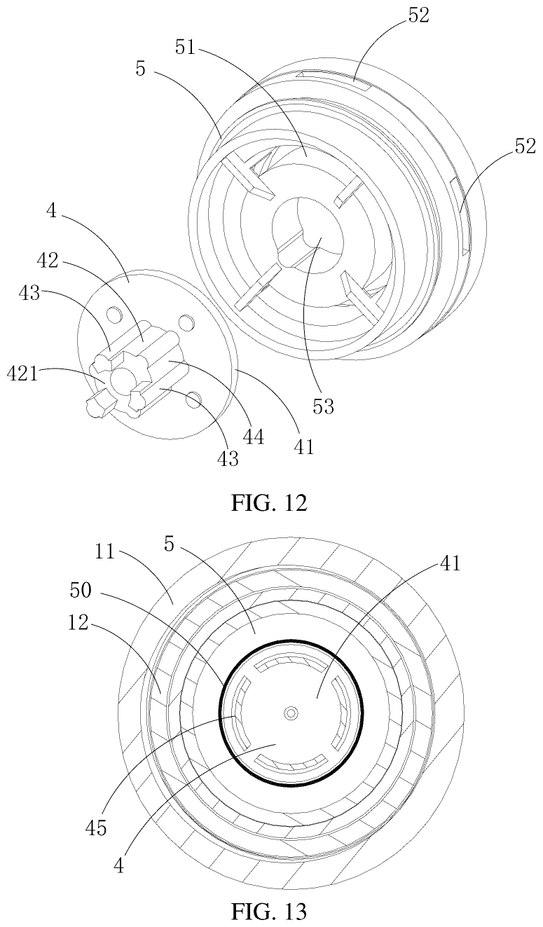

In another illustrative embodiment, as shown in FIGS. 11-13, the width between the side surface of the pressure bearing plate 41 and the side surface of the mounting groove 54 is the same, and the acceleration passage 50 is configured as an annular passage with a uniform width. The mixing flow passage 51 is configured as an annular passage and the acceleration passage 50 is aligned with the inlet port of the mixing flow passage 51. The mixing flow passage 51 surrounds the slideway 53 and surrounds the first return passage 40. In this embodiment, the mounting groove 54 is configured as a circular groove, the pressure bearing plate 41 is configured as a disc shape, and the mounting groove 54, the pressure bearing plate 41, the mixing flow passage 51, the slideway 53, and the dirt outlet 21 are coaxially provided.

In this way, the acceleration passage 50 having an annular cross section may uniformly inject high-speed water flow into the inlet port of the annular mixing flow passage 51 in the circumferential direction of the mixing flow passage 51, and further, the outlet port of the annular mixing flow passage 51 may uniformly output the water-gas mixed fluid. When a part of the water-gas mixed fluid flows back to the first return passage 40, dirt is driven from the edge of the aerator mesh 2 to the dirt outlet 21, so that dirt fallen off throughout the aerator mesh 2 may be driven to the dirt outlet 21, which may remove the dirt completely. At the same time, the cross section of the acceleration passage 50 of such structure may be set to be larger, so that the acceleration passage 50 is not easy to be dirty and blocked. The cross-sectional area of the acceleration passage 50 of such structure may be set to be smaller, for example, the width between the side surface of the pressure bearing plate 41 and the side surface of the mounting groove 54 is set to be 0.3 mm or less. Even if the cross-sectional area of the acceleration passage 50 is set to be very small, since the acceleration member 4 may slide reciprocally with respect to the air intake frame 5 to remove scale and impurities in the acceleration passage 50, the acceleration passage 50 with a smaller cross-sectional area will not be dirty and blocked.

In an illustrative embodiment, multiple air suction holes 52 are provided on the air intake frame 5, and the multiple air suction holes 52 are provided outside the mixing flow passage 51 and are uniformly arranged around the circumferential direction of the mixing flow passage 51. Multiple air intake grooves 1311 are provided on the outer peripheral wall of the connection cylinder 131 and the multiple air intake grooves 1311 are uniformly arranged around the circumferential direction of the connection cylinder 131. The inner walls of the multiple air intake grooves 1311 and the inner wall of the inner cylinder 12 enclose the multiple air intake passages 105. The housing 1 is further provided with multiple air inlets 103, ends of the multiple air intake passages 105 communicate with the multiple air inlets 103 respectively, and the other ends of the multiple air intake passages 105 communicate with the multiple air suction holes 52 respectively. In this way, the multiple air inlets 103 may uniformly deliver the air flow to the inlet port of the mixing flow passage 51 through the multiple air intake passages 105 and the multiple air suction holes 52.

In an illustrative embodiment, as shown in FIGS. 6 and 8, the support column 42 abuts against an edge of the dirt outlet 21 of the aerator mesh 2, and an end of the support column 42 abutting against the aerator mesh 2 is provided with a communication groove 421. The mixing flow cavity 104 communicates with the dirt outlet 21 through the communication groove 421.

In this way, fluid and dirt in the mixing flow cavity 104 may enter the dirt outlet 21 of the aerator mesh 2 through the communication groove 421 on the support column 42 and be removed from the dirt outlet 21, preventing the support column 42 from blocking the dirt outlet 21.

In one illustrative embodiment, the acceleration member 4 further includes multiple limiting raised ridges 43. All the multiple limiting raised ridges 43 are provided on the outer peripheral surface of the support column 42. A limiting raised ridge 43 may be a straight bar-shaped protrusion. The limiting raised ridge 43 is parallel to the support column 42, and the multiple limiting raised ridges 43 are in clearance fit with the slideway 53. The multiple limiting raised ridges 43 are uniformly distributed along the circumferential direction of the support column 42 and the first return passage 40 is formed between two adjacent limiting raised ridges 43.

A more stable sliding connection may be formed between the acceleration member 4 and the air intake frame 5 by a clearance fit between the multiple limiting raised ridges 43 and the slideway 53, and the acceleration member 4 may slide along the slideway 53 of the air intake frame 5 more stably. At the same time, a size of the first return passage 40 may be kept constant during the reciprocating sliding of the acceleration member 4.

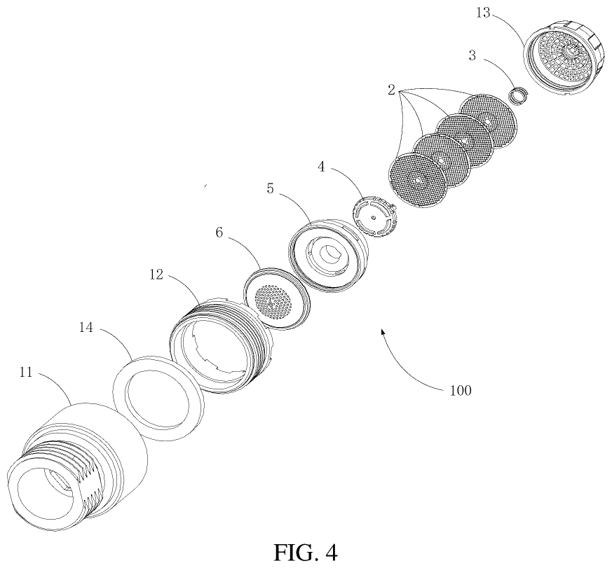

In an illustrative embodiment, as shown in FIGS. 4 and 6, the aerator 100 further includes a filter screen 6. The filter screen 6 is provided between the acceleration member 4 and the water inlet 101 of the housing 1 and between the air intake frame 5 and the water inlet 101 of the housing 1. The filter screen 6 includes a base 61 and a filter screen portion 62. The base 61 is configured in a shape of a circular annulus and the base 61 is fixed on the housing 1. The base 61 is provided with a water passage 611 having one end communicating with the water inlet 101. The filter screen portion 62 is configured as a mesh structure, and the filter screen portion 62 covers one end of the water passage 611 of the base close to the water inlet 101 of the housing 1.

The acceleration member 4 further includes a water retaining raised ridge 45, and the water retaining raised ridge 45 is provided on a plate surface of the pressure bearing plate 41 facing the water passage 611 of the base 61.

The pressure bearing plate 41 of the acceleration member 4 covers one end of the water passage 611 of the base 61 facing away from the water inlet 101 of the housing 1 when the pressure bearing plate 41 is not subjected to water pressure. The water retaining raised ridge 45 extends into the water passage 611 and extends along an edge of an end of the water passage 611.

In this way, the water flow input from the water inlet 101 is first filtered through the filter screen portion 62 of the filter screen 6 to filter out large particle impurities, and the filtered water flow enters the water passage 611 of the base 61 to push the pressure bearing plate 41 to move toward the aerator mesh 2, so that a gap is created between the pressure bearing plate 41 and the base 61. The water flow may continue to enter the acceleration passage 50 from the gap between the pressure bearing plate 41 and the base 61. When the inlet water pressure of the water inlet 101 is low, the water retaining raised ridge 45 may hold the water flow, which may improve the water pressure borne by the pressure bearing plate 41. In this way, the water flow may push the pressure bearing plate 41 to move to the aerator mesh 2, thereby avoiding low water outflow of the aerator 100 resulting from the water flow in the water passage 611 being difficult to push the aerator mesh 2 when the inlet water pressure of the water inlet 101 is low.

In an illustrative embodiment, as shown in FIGS. 7 and 9, the water retaining raised ridge 45 is configured as an annular protrusion and is coaxial with the water passage 611 of the base 61. The water retaining raised ridge 45 is provided with multiple notches 451, and the multiple notches 451 may be uniformly distributed in the circumferential direction of the water retaining raised ridge 45.

Water flow in the water passage 611 of the base 61 may flow out of the water retaining raised ridge 45 from the notches 451 on the water retaining raised ridge 45, thereby reducing a resistance of the water retaining raised ridge 45 to the water flow and increasing the water outflow of the aerator 100.

In an illustrative embodiment, as shown in FIG. 7, the outer cylinder 11 is provided with a first positioning shoulder 110 located on a side of the internal thread of the outer cylinder 11 close to the water inlet 101. The housing 1 further includes a sealing gasket 14. The sealing gasket 14 may be an annular gasket. The sealing gasket 14 is sandwiched between the inner cylinder 12 and the first positioning shoulder 110. The sealing gasket 14 may prevent the water leakage through a gap between the outer cylinder 11 and the inner cylinder 12.

In an illustrative embodiment, as shown in FIG. 6, an inner wall of the inner cylinder 12 is provided with a second positioning shoulder 121. An outer edge portion of the air intake frame 5 and an outer edge portion of the face cover 13 are sandwiched between the second positioning shoulder 121 and the sealing gasket 14.

In this way, the outer edge portion of the air intake frame 5 and the outer edge portion of the face cover 13 are sandwiched between the second positioning shoulder 121 and the sealing gasket 14, and the air intake frame 5 and the face cover 13 may be firmly fixed in the mounting cavity 104 without moving relative to the inner cylinder 12. The assembly method is simple and reliable.

The present application also provide a water outlet device, and the water outlet device may be a device capable of discharging water outward, such as a faucet, a showerhead, or a shower device. The water outlet device includes the aerator 100 as described above. The water outlet device discharges water outward through the aerator 100, thereby generating micro-bubbles in the water outlet flow, and at the same time, the aerator 100 of the water outlet device may realize self-cleaning without being dirty and blocked.

In the description of the present application, it is to be understood that the orientations or position relationships indicated by the terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential” and the like are based on those shown in the drawings, which are only for convenience of describing the present application and simplifying the description and are not intended to indicate or imply that the referred device or element must have a particular orientation, or is constructed and operated in a particular orientation and therefore cannot be construed as a limitation on the present application.

Furthermore, the terms “first”, “second” and the like are only used for descriptive purposes and cannot be understood to indicate or imply relative importance or imply the number of technical features indicated. Thus, a feature defined with “first”, “second” or the like may explicitly or implicitly include at least one of the features.

In the description of the present application, “multiple/a plurality of” means at least two, for example, two, three and the like, unless expressly specified otherwise.

In the present application, unless otherwise expressly specified and limited, the terms “mount”, “couple”, “connect”, “fix” and the like should be understood in a broad sense. For example, “connect” may be a fixed connection, a detachable connection or an integrated connection; it may be a mechanical connection or an electrical connection; it may be a direct connection or an indirect connection through an intermediate medium, or an internal communication between two elements, or an interaction relationship between two elements, unless otherwise expressly defined. For those of ordinary skills in the art, specific meanings of the above terms in the present application can be understood according to specific situations.

In the present application, unless otherwise expressly specified and limited, the first feature being “above” or “below” the second feature may be a direct contact between the first and second features, or an indirect contact between the first and second features via an intermediate medium. Moreover, the first feature being “on”, “above” and “over” the second feature may be the first feature being directly above or obliquely above the second feature, or simply indicate that the level of the first feature is higher than that of the second feature. The first feature being “under”, “below” and “underneath” the second feature may mean that the first feature is directly below or obliquely below the second feature, or simply mean that the level of the first feature is lower than that of the second feature.

In the description of this specification, descriptions with reference to terms “one embodiment”, “some embodiments”, “example”, “specific example” or “some examples”, and the like mean that specific features, structures, materials, or characteristics described in conjunction with the embodiment or example are included in at least one embodiment or example of the present application. In this specification, the schematic illustration of the above terms does not need to be directed to the same embodiments or examples. Further, the specific features, structures, materials, or characteristics described may be combined in a suitable manner in any one or more embodiments or examples. Further, those skilled in the art may incorporate and combine different embodiments or examples and features of different embodiments or examples described in this specification if there is no conflict.

Although the embodiments of the present application have been illustrated and described above, it may be understood that the above-described embodiments are exemplary and cannot be construed as a restriction on the present application. Changes, modifications, substitutions and variations may be made to the above-described embodiments by those of ordinary skills in the art within the scope of the present application.

1. An aerator, comprising:
a housing, provided with a mounting cavity and a water inlet, a water outlet and an air inlet all communicated with the mounting cavity;
an aerator mesh having flexibility or elasticity, an edge of the aerator mesh being connected to the housing, and the aerator mesh being capable of covering the water outlet, and provided with a plurality of first mesh holes and a dirt outlet having a cross-sectional area larger than that of a first mesh hole;
an acceleration member, provided in the mounting cavity and slidable in a direction toward the aerator mesh and in a direction away from the aerator mesh, wherein the acceleration member abuts against an area of the aerator mesh close to the dirt outlet; and
an elastic member, for applying an elastic force toward the acceleration member to the area of the aerator mesh close to the dirt outlet;
wherein the acceleration member is configured to slide in the direction toward the aerator mesh under an action of a water flow, so as to prop the aerator mesh to arch in a direction away from the acceleration member.

2. The aerator according to claim 1, wherein the dirt outlet is provided in a central portion of the aerator mesh.

3. The aerator according to claim 1, wherein a plurality of aerator meshes are provided, the plurality of aerator meshes are sequentially stacked, and dirt outlets of the plurality of aerator meshes are aligned in a stacking direction of the aerator meshes.

4. The aerator according to claim 1, further comprising an air intake frame disposed within the mounting cavity;
wherein the acceleration member is slidably connected to the air intake frame, and the acceleration member is configured to accelerate the water flow input from the water inlet into the mounting cavity; and
wherein the air intake frame is configured to suck external air from the air inlet by a negative pressure generated by the accelerated water flow to cause the water flow and the air to mix into a water-gas mixed fluid, and to spray the water-gas mixed fluid toward the aerator mesh.

5. The aerator according to claim 4, wherein the air intake frame is provided with a mixing flow passage and an air suction hole; one end of the mixing flow passage is provided with an inlet port communicated with the water inlet and the other end of the mixing flow passage is provided with an outlet port facing the aerator mesh; one end of the air suction hole is communicated with the inlet port of the mixing flow passage and the other end of the air suction hole is communicated with the air inlet.

6. The aerator according to claim 5, wherein one end of the air intake frame facing the water inlet is provided with a mounting groove, the mixing flow passage extends from an edge of a groove bottom of the mounting groove to one end of the air intake frame facing the water outlet, and the air intake frame is further provided with a slideway extending from the groove bottom of the mounting groove to one end of the air intake frame facing the water outlet;
the acceleration member comprises a pressure bearing plate provided in the mounting groove and a support column penetrating the slideway, and one end of the support column is connected to the pressure bearing plate and the other end of the support column abuts against the aerator mesh; and
wherein a side surface of the pressure bearing plate and a side surface of the mounting groove enclose an acceleration passage, one end of the acceleration passage is communicated with the water inlet, the other end of the acceleration passage faces the inlet port of the mixing flow passage, a cross-sectional area of the acceleration passage is smaller than that of the mixing flow passage, and the cross-sectional area of the acceleration passage is smaller than that of the water inlet.

7. The aerator according to claim 6, wherein the aerator mesh and the air intake frame enclose a mixing flow cavity, a gap between an inner wall of the slideway and an outer wall of the support column forms a first return passage, and a gap between the groove bottom of the mounting groove and the pressure bearing plate forms a second return passage;
one end of the first return passage is communicated with the mixing flow cavity and the other end of the first return passage is communicated with one end of the second return passage; and
the other end of the second return passage is communicated with the inlet port of the mixing flow passage.

8. The aerator according to claim 7, wherein the side surface of the pressure bearing plate is recessed inward to form a first groove, the first groove perpendicularly penetrates the pressure bearing plate, and an inner wall of the first groove and the side surface of the mounting groove enclose the acceleration passage;
a plurality of first grooves are provided, and the plurality of first grooves are uniformly distributed around a circumferential direction of the pressure bearing plate; and
the mixing flow passage is configured as an annular passage and surrounds the slideway, and the plurality of first grooves are each aligned with the mixing flow passage.

9. The aerator according to claim 7, wherein the acceleration passage is configured as an annular passage with a uniform width, the mixing flow passage is configured as an annular passage and surrounds the slideway, and the acceleration passage is aligned with the mixing flow passage.

10. The aerator according to claim 7, wherein the support column abuts against an edge of the dirt outlet of the aerator mesh, an end of the support column abutting against the aerator mesh is provided with a communication groove, and the mixing flow cavity communicates with the dirt outlet through the communication groove.

11. The aerator according to claim 7, wherein the acceleration member further comprises a plurality of limiting raised ridges provided on an outer peripheral surface of the support column, the limiting raised ridges are parallel to the support column and in clearance fitting with the slideway, the plurality of limiting raised ridges are uniformly distributed along a circumferential direction of the support column, and the first return passage is formed between two adjacent limiting raised ridges.

12. The aerator according to claim 7, further comprising a filter screen provided between the acceleration member and the water inlet, wherein the filter screen comprises a base fixed to the housing and a filter screen portion connected to the base, the base is provided with a water passage having one end communicating with the water inlet, and the filter screen portion covers one end of the water passage close to the water inlet;
the acceleration member further comprises a water retaining raised ridge, and the water retaining raised ridge is provided on a plate surface of the pressure bearing plate facing the water passage; and
the pressure bearing plate covers one end of the water passage facing away from the water inlet when the pressure bearing plate is not subjected to water pressure, and the water retaining raised ridge extends into the water passage and extends along an edge of an end of the water passage.

13. The aerator according to claim 12, wherein the water retaining raised ridge is configured as an annular protrusion coaxial with the water passage, and the water retaining raised ridge is provided with a plurality of notches.

14. The aerator according to claim 5, wherein the housing comprises:
an outer cylinder, wherein one end of the outer cylinder is provided with the water inlet, and a first positioning shoulder is provided in the outer cylinder;
an inner cylinder, disposed within the outer cylinder and screwed with the outer cylinder;
a sealing gasket, sandwiched between the inner cylinder and the first positioning shoulder; and
a face cover, comprising a connection cylinder positioned in the inner cylinder and a support frame covering one end of the connection cylinder facing away from the water inlet, wherein a plurality of water outlets are provided on the support frame;
wherein an air intake passage is enclosed between an outer peripheral wall of the connection cylinder and an inner wall of the inner cylinder, the air intake passage extends from the air inlet to the mounting cavity and communicates with the air suction hole, the face cover and the inner cylinder enclose the mounting cavity, the aerator mesh is sandwiched between the support frame and the air intake frame, and the elastic member is sandwiched between the support frame and the aerator mesh.

15. A water outlet device, comprising the aerator according to claim 1.

16. The aerator according to claim 6, wherein the housing comprises:
an outer cylinder, wherein one end of the outer cylinder is provided with the water inlet, and a first positioning shoulder is provided in the outer cylinder;
an inner cylinder, disposed within the outer cylinder and screwed with the outer cylinder;
a sealing gasket, sandwiched between the inner cylinder and the first positioning shoulder; and
a face cover, comprising a connection cylinder positioned in the inner cylinder and a support frame covering one end of the connection cylinder facing away from the water inlet, wherein a plurality of water outlets are provided on the support frame;
wherein an air intake passage is enclosed between an outer peripheral wall of the connection cylinder and an inner wall of the inner cylinder, the air intake passage extends from the air inlet to the mounting cavity and communicates with the air suction hole, the face cover and the inner cylinder enclose the mounting cavity, the aerator mesh is sandwiched between the support frame and the air intake frame, and the elastic member is sandwiched between the support frame and the aerator mesh.

17. The aerator according to claim 7, wherein the housing comprises:
an outer cylinder, wherein one end of the outer cylinder is provided with the water inlet, and a first positioning shoulder is provided in the outer cylinder;
an inner cylinder, disposed within the outer cylinder and screwed with the outer cylinder;
a sealing gasket, sandwiched between the inner cylinder and the first positioning shoulder; and
a face cover, comprising a connection cylinder positioned in the inner cylinder and a support frame covering one end of the connection cylinder facing away from the water inlet, wherein a plurality of water outlets are provided on the support frame;
wherein an air intake passage is enclosed between an outer peripheral wall of the connection cylinder and an inner wall of the inner cylinder, the air intake passage extends from the air inlet to the mounting cavity and communicates with the air suction hole, the face cover and the inner cylinder enclose the mounting cavity, the aerator mesh is sandwiched between the support frame and the air intake frame, and the elastic member is sandwiched between the support frame and the aerator mesh.

18. A water outlet device, comprising the aerator according to claim 2.

19. A water outlet device, comprising the aerator according to claim 3.

20. A water outlet device, comprising the aerator according to claim 4.
